(19) United States
(12) Patent Application Publication
(10) Pub. No.: US 2024/0328628 A1
(43) Pub. Date: Oct. 3, 2024

(54) ANTI-DRY-BURN COOKTOP AND CONTROL METHOD THEREFOR

(71) Applicant: BSH Hausgeräte GmbH, Munich (DE)

(72) Inventor: Jinhua Wu, Nanjing City, Jiangsu Province (CN)

(21) Appl. No.: 18/681,525

(22) PCT Filed: Aug. 24, 2022
(86) PCT No.: PCT/EP2022/073548

§ 371 Date: Feb. 6, 2024

(30) Foreign Application Priority Data
Sep. 3, 2021 (CN) 202111031217.5

(51) Int. Cl. F24C 3/12; A23L 5/10; A47J 36/32; G01J 5/00; G08B 21/18

(52) U.S. Cl. CPC F24C 3/126; A23L 5/10; A47J 36/32; G01J 5/0025; G08B 21/182

(57) ABSTRACT

An anti-dry-burn cooktop includes a temperature sensor collecting a temperature of a pot; a control unit storing first and second temperature thresholds, with the first temperature threshold being less than the second temperature threshold, an alarm unit transmitting alarm information based on an instruction of the control unit, and a user determining unit determining the presence or absence of a person around the cooktop and transmitting determination information to the control unit. When the temperature of the pot is greater than the first temperature threshold and less than the second temperature threshold, and information determining the presence of a person around the cooktop is transmitted, the control unit controls the alarm unit not to transmit the alarm information; and when the information determining the absence of a person around the cooktop is transmitted, the control unit controls the alarm unit to transmit the alarm information.

### TECHNICAL FIELD

The present invention relates to the field of kitchen appliances, and in particular, to an anti-dry-burn cooktop and a control method therefor.

### BACKGROUND

In the related art, an anti-dry-burn function that is set in a household cooktop can automatically turn off the cooktop when the temperature of a pot reaches the anti-dry-burn temperature threshold. However, to ensure that a pot with oil is not likely to catch fire, an anti-dry-burn temperature is set relatively low, which leads to the problem of turning off the fire unexpected early in some high-temperature cooking occasions, affecting the cooking effect.

### SUMMARY

The present invention aims at providing an improved anti-dry-burn cooktop and a control method.

An aspect of embodiments of the present invention relates to an anti-dry-burn cooktop. The anti-dry-burn cooktop includes a solenoid valve and a temperature sensor. The temperature sensor is configured to collect a temperature of a pot; a control unit storing a first temperature threshold and a second temperature threshold, where the first temperature threshold is less than the second temperature threshold; an alarm unit, configured to transmit alarm information based on an instruction of the control unit; and a user determining unit, configured to determine whether there is somebody around the cooktop and transmit determination information to the control unit, where the control unit is set as follows: in a case that the temperature of the pot is greater than the first temperature threshold and less than the second temperature threshold, and information that determines there is somebody around the cooktop and is transmitted by the user determining unit is received, the control unit controls the alarm unit not to transmit the alarm information; and in a case that the temperature of the pot is greater than the first temperature threshold and less than the second temperature threshold, and information that determines there is nobody around the cooktop and is transmitted by the user determining unit is received, the control unit controls the alarm unit to transmit the alarm information.

With this structure, in a case that the temperature of the pot is greater than the first temperature threshold and less than the second temperature threshold, whether to transmit the alarm information can be determined according to whether there is somebody around the cooktop. On the one hand, a user can be informed in time that attention should be paid to the cooking condition of the cooktop before or at the beginning of dry burn of the cooktop to prevent dry burn in time. On the other hand, when there is somebody around the cooktop, the user can freely monitor the cooking condition of the cooktop, and does not need to be reminded, and therefore no alarm information is sent, which can reduce the interference of the alarm information to the user who is cooking, make the cooktop more intelligent, and improve the user experience.

In a possible implementation, the control unit is further set as follows: in a case that the temperature of the pot is greater than the second temperature threshold, the control unit controls the solenoid valve to close. This can not only meet the needs of the user for high-temperature cooking, but also reduce the possibility of dry burn, improve the safety of the cooktop, and improve the user experience.

In a possible implementation, the anti-dry-burn cooktop further includes a user feedback receiving unit, configured to receive an instruction from a user for the generation of the alarm information and transmit the instruction to the control unit; and the control unit is further set as follows: after the alarm unit transmits the alarm information, the user feedback receiving unit receives the alarm information, generates an instruction of turning off the fire, and transmits the instruction to the control unit; and after receiving the instruction of turning off the fire from the user feedback receiving unit, the control unit controls the solenoid valve to close.

In this way, after the alarm information is transmitted, the user makes different reactions according to the alarm information, for example, the user cancels alarm through an alarm canceling button, the user performs a corresponding operation on an APP, the user has not received the alarm information and has no reaction, or the user intends to turn off the fire immediately. The user feedback receiving unit generates different instructions according to these reactions and transmits the different instructions to the control unit. If the user has no reaction or intends to turn off the fire after the alarm information is transmitted, the user feedback receiving unit generates the instruction of turning off the fire according to these reactions and transmits the instruction of turning off the fire to the control unit to close the solenoid valve to prevent dry burn and ensure the safety of the cooktop.

In a possible implementation, the user feedback receiving unit is configured to receive an instruction from a user for the generation of the alarm information and transmit the instruction to the control unit; and the control unit is further set as follows: after the alarm unit transmits the alarm information, the user feedback receiving unit receives the alarm information, generates an instruction for closing the alarm information, and transmits the instruction to the control unit; and after receiving the instruction for closing the alarm information from the user feedback receiving unit, the control unit controls the alarm unit to stop transmitting the alarm information.

In this way, after the alarm information is transmitted, the user makes different reactions according to the alarm information, for example, the user cancels the alarm through the alarm canceling button, the user performs a corresponding operation on the APP, or the user has not received the alarm information and has no reaction. The user feedback receiving unit generates different instructions according to these reactions and transmits the different instructions to the control unit. If the user needs a high-temperature cooking environment, the user can operate the alarm canceling button or carry out a corresponding operation on the APP, and then the user feedback receiving unit transmits the instruction for closing the alarm information according to these reactions. The alarm unit stops transmitting the alarm information, and the solenoid valve does not act to achieve the high-temperature cooking environment required by the user, meet the personalized needs of the user, and improve the user experience.

In a possible implementation, the first temperature threshold is based on a temperature collected by the temperature sensor in a case that a small amount of oil is put into the pot and the oil does not catch fire. In this way, the first temperature threshold of the cooktop can be accurately obtained to prevent misjudgment of dry burn prevention and improve the user experience.

In a possible implementation, a range of the first temperature threshold is less than or equal to 240 degrees and greater than or equal to 260 degrees.

In a possible implementation, in a case that the temperature in the pot is 300 degrees, the temperature collected by the temperature sensor is a first temperature; in a case that an ambient temperature of the temperature sensor reaches a maximum value, the temperature collected by the temperature sensor is a second temperature; and the second temperature threshold takes a smaller value of the first temperature and the second temperature. In this way, under the condition that the temperature of the temperature sensor does not exceed the maximum ambient temperature and the oil in the pot does not catch fire, the second temperature threshold is taken as large as possible, which can not only meet the safety conditions, but also meet the needs of high-temperature cooking and improve the user experience.

In a possible implementation, a range of the second temperature threshold is less than or equal to 280 degrees and greater than or equal to 300 degrees.

In a possible implementation, the user determining unit includes a human body detection unit arranged around the cooktop, and the human body detection unit is configured to determine whether there is somebody around the cooktop and transmit determination information to the control unit. In this way, a human body detection unit can quickly and accurately determine whether there is somebody around the cooktop, which makes the cooktop more intelligent.

“The human body detection unit is arranged around the cooktop” of the present invention includes that the human body detection unit is arranged on a cupboard or stove that is relatively close to the cooktop, can also be arranged on another household appliance terminal that is relatively close to the cooktop, and can also be arranged on the cooktop.

In a possible implementation, the human body detection unit includes an infrared temperature sensor.

In a possible implementation, the anti-dry-burn cooktop further includes a panel and a gas valve knob on the panel, the user determining unit includes a position sensor arranged on the gas valve knob, and the position sensor is configured to detect whether a position of the gas valve knob changes within a certain period of time to determine whether there is somebody around the cooktop.

In this way, when the position of the gas valve knob changes within a certain period of time, it is determined that there is somebody around the cooktop; when the position of the gas valve knob does not change within a certain period of time, it is determined that there is nobody around the cooktop. This makes the cooktop more intelligent.

The present invention further aims at providing a control method for an anti-dry-burn cooktop. The cooktop includes a solenoid valve and a temperature sensor, where the temperature sensor is configured to collect a temperature of a pot; a control unit storing a first temperature threshold and a second temperature threshold, where the first temperature threshold is less than the second temperature threshold; an alarm unit, configured to transmit alarm information based on an instruction of the control unit; and a user determining unit, configured to determine whether there is somebody around the cooktop and transmit determination information to the control unit; and the control method includes:
collecting, by the temperature sensor, the temperature of the pot; and
determining whether the temperature of the pot is greater than the first temperature threshold and less than the second temperature threshold, and whether information that determines there is somebody around the cooktop and is transmitted by the user determining unit is received, where

if the temperature of the pot is greater than the first temperature threshold and less than the second temperature threshold, and information that determines there is somebody around the cooktop and is transmitted by the user determining unit is received, the control unit controls the alarm unit not to transmit the alarm information; and if the temperature of the pot is greater than the first temperature threshold and less than the second temperature threshold, and information that determines there is nobody around the cooktop and is transmitted by the user determining unit is received, the control unit controls the alarm unit to transmit the alarm information.

With this method, in a case that the temperature of the pot is greater than the first temperature threshold and less than the second temperature threshold, whether to transmit the alarm information can be determined according to whether there is somebody around the cooktop. On the one hand, the user can be informed in time that attention should be paid to the cooking condition of the cooktop before or at the beginning of dry burn of the cooktop. On the other hand, when there is somebody around the cooktop, the user can monitor the cooking condition of the cooktop, and does not need to be reminded, and therefore no alarm information is sent, which can reduce the interference of the alarm information to the user who is cooking, make the cooktop more intelligent, and improve the user experience.

In a possible implementation, the control method further includes: c. in a case that the temperature of the pot is greater than the second temperature threshold, controlling, by the control unit, the solenoid valve to close. This can not only meet the needs of the user for high-temperature cooking, but also reduce the possibility of dry burn, improve the safety of the cooktop, and improve the user experience.

In a possible implementation, the anti-dry-burn cooktop further includes a user feedback receiving unit, configured to receive an instruction from a user for the generation of the alarm information and transmit the instruction to the control unit; and the control method further includes: d. after the alarm unit transmits the alarm information, receiving, by the user feedback receiving unit, the alarm information, generating an instruction of turning off the fire, and transmitting the instruction to the control unit; and after receiving the instruction of turning off the fire from the user feedback receiving unit, controlling, by the control unit, the solenoid valve to close.

In this way, after the alarm information is transmitted, the user makes different reactions according to the alarm information, for example, the user cancels the alarm through the alarm canceling button, the user performs a corresponding operation on an APP, or the user has not received the alarm information and has no reaction. The user feedback receiving unit generates different instructions according to these reactions and transmits the different instructions to the control unit. If the user has no reaction or intends to turn off the fire after the alarm information is transmitted, the user feedback receiving unit generates the instruction of turning off the fire according to these reactions and transmits the instruction of turning off the fire to the control unit to close the solenoid valve to prevent dry burn and ensure the safety of the cooktop.

In a possible implementation, the anti-dry-burn cooktop further includes a user feedback receiving unit, configured to receive an instruction from a user for the generation of the alarm information and transmit the instruction to the control unit; and the control method further includes: e. after the alarm unit transmits the alarm information, receiving, by the user feedback receiving unit, the alarm information, generating an instruction for closing the alarm information, and transmitting the instruction to the control unit; and after receiving the instruction for closing the alarm information from the user feedback receiving unit, controlling, by the control unit, the alarm unit to stop transmitting the alarm information.

In this way, after the alarm information is transmitted, the user makes different reactions according to the alarm information, for example, the user cancels the alarm through the alarm canceling button, the user performs a corresponding operation on an APP, or the user has not received the alarm information and has no reaction. The user feedback receiving unit generates different instructions according to these reactions and transmits the different instructions to the control unit. If the user needs a high-temperature cooking environment, the user can operate the alarm canceling button or carry out a corresponding operation on the APP, and then the user feedback receiving unit transmits the instruction for closing the alarm information according to these reactions. The alarm unit stops transmitting the alarm information, and the solenoid valve does not act to achieve the high-temperature cooking environment required by the user, mect the personalized needs of the user, and improve the user experience.

In a possible implementation, the first temperature threshold is based on a temperature collected by the temperature sensor in a case that a small amount of oil is put into the pot and the oil does not catch fire. In this way, the first temperature threshold of the cooktop can be accurately obtained to prevent misjudgment of dry burn prevention and improve the user experience.

In a possible implementation, a range of the first temperature threshold is less than or equal to 240 degrees and greater than or equal to 260 degrees.

In a possible implementation, in a case that the temperature in the pot is 300 degrees, the temperature collected by the temperature sensor is a first temperature; in a case that an ambient temperature of the temperature sensor reaches a maximum value, the temperature collected by the temperature sensor is a second temperature; and the second temperature threshold takes a smaller value of the first temperature and the second temperature. In this way, under the condition that the temperature of the temperature sensor does not exceed the maximum ambient temperature and the oil in the pot does not catch fire, the second temperature threshold is taken as large as possible, which can not only meet the safety conditions, but also meet the needs of high-temperature cooking and improve the user experience.

In a possible implementation, a range of the second temperature threshold is less than or equal to 280 degrees and greater than or equal to 300 degrees.

### BRIEF DESCRIPTION OF THE DRAWINGS

FIG. 1 is a principle diagram of an electrical appliance of an embodiment of the present invention; and

FIG. 2 is a flowchart of a control method of an embodiment of the present invention.

### LIST OF REFERENCE NUMERALS

Control unit 100
Alarm unit 200
Temperature sensor 300
Solenoid valve 400
User feedback receiving unit 500
User determining unit 600

### DETAILED DESCRIPTION

In order to further understand the objectives, structure, features, and functions of the present invention, the present invention is described in detail with reference to the embodiments as follows:

An anti-dry-burn cooktop of an implementation of the present invention includes a solenoid valve 400, and includes a cooktop body and a control unit 100. The cooktop body is provided with a burner head, a pot is placed on a pot support, and fire generated by the burner head is used for heating the pot on the pot support.

The control unit 100 pre-stores a first temperature threshold and a second temperature threshold. The first temperature threshold is less than the second temperature threshold.

The cooktop further includes a gas pipeline and a gas valve mounted in the gas pipeline, the gas pipeline is connected to the cooktop body, and the gas pipeline supplies gas to the cooktop body. The gas valve is a plug valve. A user can manually adjust a knob of the gas valve to adjust the gas flow supplied to a burner to control the flame size of the burner head.

The cooktop further includes a solenoid valve 400, and the solenoid valve 400 and the gas valve are connected in series and are mounted in the gas pipeline. The control unit 100 is connected to the solenoid valve 400 and controls the solenoid valve 400 to open or close to control gas supply.

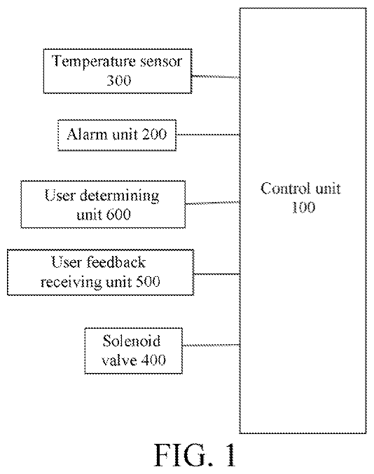

As shown in FIG. 1, the cooktop further includes a temperature sensor 300 and an alarm unit 200. The temperature sensor 300 is configured to collect a temperature of the pot, and the alarm unit 200 is configured to transmit alarm information. The control unit 100 is electrically connected to the temperature sensor 300 and the alarm unit 200, the temperature sensor 300 transmits information about the collected temperature of the pot to the control unit 100, and the alarm unit 200 transmits the alarm information based on an instruction transmitted by the control unit 100.

The cooktop further includes a user feedback receiving unit 500 electrically connected to the control unit 100, and configured to receive an instruction from the user for the generation of the alarm information and transmit the instruction to the control unit 100.

After the alarm information is transmitted, the user makes different reactions according to the alarm information, for example, the user cancels alarm through an alarm canceling button, the user performs a corresponding operation on an APP, the user has not received the alarm information and has no reaction, or the user intends to turn off the fire automatically. The user feedback receiving unit 500 generates different instructions according to these reactions of the user and transmits the different instructions to the control unit 100.

The cooktop further includes a user determining unit 600 electrically connected to the control unit 100, and configured to determine whether there is somebody around the cooktop and transmit determination information to the control unit 100.

In an embodiment, the user determining unit 600 includes a human body detection unit arranged around the cooktop, and the human body detection unit is configured to determine whether there is somebody around the cooktop and transmit determination information to the control unit 100. The human body detection unit can include an infrared temperature sensor.

“The human body detection unit is arranged around the cooktop” can include that the human body detection unit is arranged on a cupboard or stove that is relatively close to the cooktop, can also be arranged on another household appliance terminal that is relatively close to the cooktop, and can also be arranged on the cooktop.

In another embodiment, the cooktop further includes a panel and a gas valve knob on the panel, the user determining unit 600 includes a position sensor arranged on the gas valve knob, and the position sensor is configured to detect whether a position of the gas valve knob changes to determine whether there is somebody around the cooktop.

When the position of the gas valve knob changes within a certain period of time, it is determined that there is somebody around the cooktop; when the position of the gas valve knob does not change within a certain period of time, it is determined that there is nobody around the cooktop.

The control unit 100 is set as follows: in a case that the temperature of the pot is greater than the first temperature threshold and less than the second temperature threshold, and information that determines there is somebody around the cooktop and is transmitted by the user determining unit 600 is received, the control unit 100 controls the alarm unit 200 not to transmit the alarm information; and in a case that the temperature of the pot is greater than the first temperature threshold and less than the second temperature threshold, and information that determines there is nobody around the cooktop and is transmitted by the user determining unit 600 is received, the control unit 100 controls the alarm unit 200 to transmit the alarm information.

With this structure, in a case that the temperature of the pot is greater than the first temperature threshold and less than the second temperature threshold, whether to transmit the alarm information can be determined according to whether there is somebody around the cooktop. On the one hand, the user can be informed in time that attention should be paid to the cooking condition of the cooktop before or at the beginning of dry burn of the cooktop to prevent dry burn. On the other hand, when there is somebody around the cooktop, the user can freely monitor the cooking condition of the cooktop, and does not need to be reminded, and therefore no alarm information is sent, which can reduce the interference of the alarm information to the user who is cooking, make the cooktop more intelligent, and improve the user experience.

The control unit 100 is further set as follows: in a case that the temperature of the pot is greater than the second temperature threshold, the control unit 100 transmits an instruction for closing to the solenoid valve 400 and controls the solenoid valve 400 to close. In this way, the gas supply to the burner through the gas supply pipeline is cut off to cause the cooktop to be turned off. This not only meets the needs of the user for high-temperature cooking, but also ensures the safety of the cooktop, improves the intelligence of the cooktop, and improves the user experience.

The control unit 100 is further set as follows: after the alarm unit 200 transmits the alarm information, the user feedback receiving unit 500 receives the alarm information, generates an instruction of turning off the fire, and transmits the instruction to the control unit 100; and after receiving the instruction of turning off the fire from the user feedback receiving unit 500, the control unit 100 controls the solenoid valve 400 to close.

In this way, if the user has no reaction or intends to turn off the fire after the alarm information is transmitted, the user feedback receiving unit 500 generates the instruction of turning off the fire according to these reactions and transmit the instruction of turning off the fire to the control unit 100 to close the solenoid valve 400 to prevent dry burn and ensure the safety of the cooktop.

After the alarm unit 200 transmits the alarm information, the user feedback receiving unit receives the alarm information, generates an instruction for closing the alarm information, and transmits the instruction to the control unit 100. After receiving the instruction for closing the alarm information from the user feedback receiving unit 500, the control unit 100 controls the alarm unit 200 to stop transmitting the alarm information.

In this way, if the user needs a high-temperature cooking environment, the user can operate the alarm canceling button or carry out a corresponding operation on the APP, and then the user feedback receiving unit 500 transmits the instruction for closing the alarm information according to these reactions. The alarm unit 200 stops transmitting the alarm information, and the solenoid valve 400 does not act, to continuously supply gas, to achieve the high-temperature cooking environment required by the user, meet the personalized needs of the user, and improve the user experience.

The first temperature threshold is based on a temperature collected by the temperature sensor 300 in a case that a small amount of oil is put into the pot and the oil does not catch fire. A range of the first temperature threshold is less than or equal to 240 degrees and greater than or equal to 260 degrees.

In a case that the temperature in the pot is 300 degrees, the temperature collected by the temperature sensor 300 is a first temperature; in a case that an ambient temperature of the temperature sensor 300 reaches a maximum value, the temperature collected by the temperature sensor 300 is a second temperature; and the second temperature threshold takes a smaller value of the first temperature and the second temperature. A range of the second temperature threshold is less than or equal to 280 degrees and greater than or equal to 300 degrees.

In this way, under the condition that the temperature of the temperature sensor 300 does not exceed the maximum ambient temperature and the oil in the pot does not catch fire, the second temperature threshold is taken as large as possible, which can not only meet the safety conditions and ensure that the temperature sensor 300 is not damaged, but also meet the needs of high-temperature cooking and improve the user experience. The alarm information can take different forms.

In an embodiment, the alarm information can include sound, and a frequency of the sound is positively correlated with a temperature of an alarm range; and/or the alarm information includes light, and a flashing frequency of light is positively correlated with a temperature of the alarm range.

In another embodiment, the alarm information can further include a buzzer, an LED indicator, or a voice broadcast.

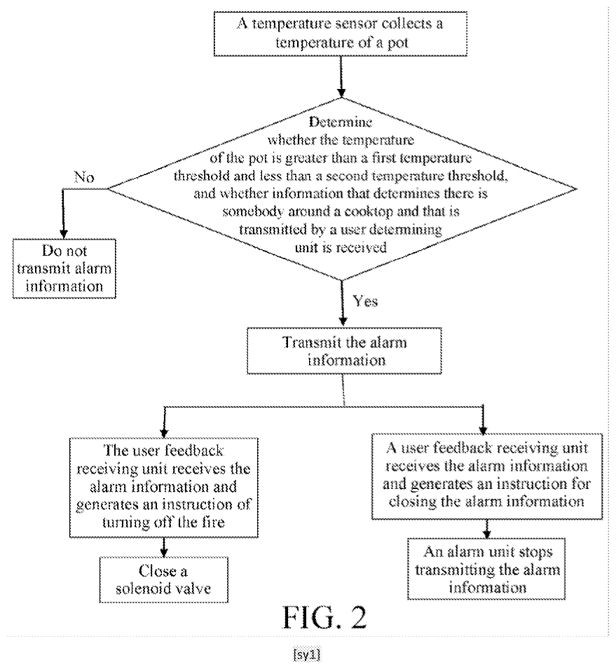

As shown in FIG. 2, the present invention further provides a technical solution as follows: a cooktop includes a solenoid valve 400 and a temperature sensor 300, where the temperature sensor 300 is configured to collect a temperature of a pot; a control unit 100 storing a first temperature threshold and a second temperature threshold, where the first temperature threshold is less than the second temperature threshold; an alarm unit 200, configured to transmit alarm information based on an instruction of the control unit 100; and a user determining unit 600, configured to determine whether there is somebody around the cooktop and transmit determination information to the control unit 100; and a control method includes: collecting, by the temperature sensor 300, the temperature of the pot; and

determining whether the temperature of the pot is greater than the first temperature threshold and less than the second temperature threshold, and whether information that determines there is somebody around the cooktop and is transmitted by the user determining unit 600 is received, where

if the temperature of the pot is greater than the first temperature threshold and less than the second temperature threshold, and information that determines there is somebody around the cooktop and is transmitted by the user determining unit 600 is received, the control unit 100 controls the alarm unit 200 not to transmit the alarm information; and if the temperature of the pot is greater than the first temperature threshold and less than the second temperature threshold, and information that determines there is nobody around the cooktop and is transmitted by the user determining unit 600 is received, the control unit 100 controls the alarm unit 200 to transmit the alarm information.

With this method, in a case that the temperature of the pot is greater than the first temperature threshold and less than the second temperature threshold, whether to transmit the alarm information can be determined according to whether there is somebody around the cooktop. On the one hand, the user can be informed in time that attention should be paid to the cooking condition of the cooktop before or at the beginning of dry burn of the cooktop. On the other hand, when there is somebody around the cooktop, the user can monitor the cooking condition of the cooktop, and does not need to be reminded, and therefore no alarm information is sent, which can reduce the interference of the alarm information to the user who is cooking, make the cooktop more intelligent, and improve the user experience.

The setting of the first temperature threshold and the second temperature threshold has been described above, and will not be repeated herein.

The control method may further include: c. in a case that the temperature of the pot is greater than the second temperature threshold, controlling, by the control unit 100, the solenoid valve 400 to close.

This can not only meet the needs of the user for high-temperature cooking, but also reduce the possibility of dry burn, improve the safety of the cooktop, and improve the user experience.

The control method may further include: d. after the alarm unit 200 transmits the alarm information, receiving, by the user feedback receiving unit 500, the alarm information, generating an instruction of turning off the fire, and transmitting the instruction to the control unit 100; and after receiving the instruction of turning off the fire from the user feedback receiving unit 500, controlling, by the control unit 100, the solenoid valve 400 to close.

If the user has no reaction or intends to turn off the fire after the alarm information is transmitted, the user feedback receiving unit 500 generates the instruction of turning off the fire according to these reactions and transmits the instruction of turning off the fire to the control unit 100 to close the solenoid valve 400 to prevent dry burn and ensure the safety of the cooktop.

The control method may further include: e. after the alarm unit 200 transmits the alarm information, receiving, by the user feedback receiving unit, the alarm information, generating an instruction for closing the alarm information, and transmitting the instruction to the control unit 100; and after receiving the instruction for closing the alarm information from the user feedback receiving unit 500, controlling, by the control unit 100, the alarm unit 200 to stop transmitting the alarm information.

If the user needs a high-temperature cooking environment, the user can operate an alarm canceling button or carry out a corresponding operation on the APP, and then the user feedback receiving unit 500 transmits the instruction for closing the alarm information according to these reactions. The alarm unit 200 stops transmitting the alarm information, and the solenoid valve 400 does not act to achieve the high-temperature cooking environment required by the user, meet the personalized needs of the user, and improve the user experience.

The various embodiments described with reference to FIG. 1 to FIG. 2 may be combined with each other in any given manner to realize the advantages of the present invention. In addition, the present invention is not limited to the shown embodiments. Usually, apart from the shown means, other means can also be used as long as the means can also achieve the same effect.

What is claimed is:

1. An anti-dry-burn cooktop, comprising a solenoid valve (400) and a temperature sensor (300), the temperature sensor (300) being configured to collect a temperature of a pot; and
characterized by comprising:
a control unit (100) storing a first temperature threshold and a second temperature threshold, the first temperature threshold being less than the second temperature threshold;
an alarm unit (200), configured to transmit alarm information based on an instruction of the control unit (100); and
a user determining unit (600), configured to determine whether there is somebody around the cooktop and transmit determination information to the control unit (100), wherein the control unit (100) is set as follows: in a case that the temperature of the pot is greater than the first temperature threshold and less than the second temperature threshold, and information that determines there is somebody around the cooktop and is transmitted by the user determining unit (600) is received, the control unit (100) controls the alarm unit (200) not to transmit the alarm information; and in a case that the temperature of the pot is greater than the first temperature threshold and less than the second temperature threshold, and information that determines there is nobody around the cooktop and is transmitted by the user determining unit (600) is received, the control unit (100) controls the alarm unit (200) to transmit the alarm information.

2. The anti-dry-burn cooktop according to claim 1, characterized in that the control unit (100) is further set as follows: in a case that the temperature of the pot is greater than the second temperature threshold, the control unit (100) controls the solenoid valve (400) to close.

3. The anti-dry-burn cooktop according to claim 1, characterized in that the anti-dry-burn cooktop further comprises a user feedback receiving unit (500), configured to receive an instruction from a user for the generation of the alarm information and transmit the instruction to the control unit (100); and
the control unit (100) is further set as follows: after the alarm unit (200) transmits the alarm information, the user feedback receiving unit (500) receives the alarm information, generates an instruction of turning off the fire, and transmits the instruction to the control unit (100); and after receiving the instruction of turning off the fire from the user feedback receiving unit (500), the control unit (100) controls the solenoid valve (400) to close.

4. The anti-dry-burn cooktop according to claim 1, characterized in that the anti-dry-burn cooktop further comprises a user feedback receiving unit (500), configured to receive an instruction from a user for the generation of the alarm information and transmit the instruction to the control unit (100); and
the control unit (100) is further set as follows: after the alarm unit (200) transmits the alarm information, the user feedback receiving unit receives the alarm information, generates an instruction for closing the alarm information, and transmits the instruction to the control unit (100); and after receiving the instruction for closing the alarm information from the user feedback receiving unit (500), the control unit (100) controls the alarm unit (200) to stop transmitting the alarm information.

5. The anti-dry-burn cooktop according to claim 1, characterized in that the first temperature threshold is based on a temperature collected by the temperature sensor (300) in a case that a small amount of oil is put into the pot and the oil does not catch fire.

6. The anti-dry-burn cooktop according to claim 1, characterized in that a range of the first temperature threshold is less than or equal to 240 degrees and greater than or equal to 260 degrees.

7. The anti-dry-burn cooktop according to claim 1, characterized in that in a case that the temperature in the pot is 300 degrees, the temperature collected by the temperature sensor (300) is a first temperature; in a case that an ambient temperature of the temperature sensor (300) reaches a maximum value, the temperature collected by the temperature sensor (300) is a second temperature; and the second temperature threshold takes a smaller value of the first temperature and the second temperature.

8. The anti-dry-burn cooktop according to claim 1, characterized in that a range of the second temperature threshold is less than or equal to 280 degrees and greater than or equal to 300 degrees.

9. The anti-dry-burn cooktop according to claim 1, characterized in that the user determining unit (600) comprises a human body detection unit arranged around the cooktop, and the human body detection unit is configured to determine whether there is somebody around the cooktop and transmit determination information to the control unit (100).

10. The anti-dry-burn cooktop according to claim 9, characterized in that the human body detection unit comprises an infrared temperature sensor.

11. The anti-dry-burn cooktop according to claim 1, characterized in that the anti-dry-burn cooktop further comprises a panel and a gas valve knob on the panel, the user determining unit (600) comprises a position sensor arranged on the gas valve knob, and the position sensor is configured to detect whether a position of the gas valve knob changes within a certain period of time to determine whether there is somebody around the cooktop.

12. A control method for an anti-dry-burn cooktop, wherein the cooktop comprises a solenoid valve (400) and a temperature sensor (300), wherein the temperature sensor (300) is configured to collect a temperature of a pot; a control unit (100) storing a first temperature threshold and a second temperature threshold, wherein the first temperature threshold is less than the second temperature threshold; an alarm unit (200), configured to transmit alarm information based on an instruction of the control unit (100); and a user determining unit (600) is configured to determine whether there is somebody around the cooktop and transmit determination information to the control unit (100),
characterized in that the control method comprises:
a. collecting, by the temperature sensor (300), the temperature of the pot; and
b. determining whether the temperature of the pot is greater than the first temperature threshold and less than the second temperature threshold, and whether information that determines there is somebody around the cooktop and is transmitted by the user determining unit (600) is received;
if the temperature of the pot is greater than the first temperature threshold and less than the second temperature threshold, and information that determines there is somebody around the cooktop and is transmitted by the user determining unit (600) is received, controlling, by the control unit (100), the alarm unit (200) not to transmit the alarm information; and if the temperature of the pot is greater than the first temperature threshold and less than the second temperature threshold, and information that determines there is nobody around the cooktop and is transmitted by the user determining unit (600) is received, controlling, by the control unit (100), the alarm unit (200) to transmit the alarm information.

13. The control method according to claim 12, characterized in that the control method further comprises: c. in a case that the temperature of the pot is greater than the second temperature threshold, controlling, by the control unit (100), the solenoid valve (400) to close.

14. The control method according to claim 12, characterized in that the anti-dry-burn cooktop further comprises a user feedback receiving unit (500), configured to receive the instruction from a user for the generation of the alarm information and transmit the instruction to the control unit (100); and
the control method further comprises: d. after the alarm unit (200) transmits the alarm information, receiving, by the user feedback receiving unit (500), the alarm information, generating an instruction of turning off the fire, and transmitting the instruction to the control unit (100); and after receiving the instruction of turning off the fire from the user feedback receiving unit (500), controlling, by the control unit (100), the solenoid valve (400) to close.

15. The control method according to claim 12, characterized in that the anti-dry-burn cooktop further comprises a user feedback receiving unit (500), configured to receive the instruction from a user for the generation of the alarm information and transmit the instruction to the control unit (100); and
the control method further comprises: e. after the alarm unit (200) transmits the alarm information, receiving, by the user feedback receiving unit, the alarm information, generating an instruction for closing the alarm information, and transmitting the instruction to the control unit (100); and after receiving the instruction for closing the alarm information from the user feedback receiving unit (500), controlling, by the control unit (100), the alarm unit (200) to stop transmitting the alarm information.

16. The control method according to claim 12, characterized in that the first temperature threshold is based on a temperature collected by the temperature sensor (300) in a case that a small amount of oil is put into the pot and the oil does not catch fire.

17. The control method according to claim 12, characterized in that a range of the first temperature threshold is less than or equal to 240 degrees and greater than or equal to 260 degrees.

18. The control method according to claim 12, characterized in that in a case that the temperature in the pot is 300 degrees, the temperature collected by the temperature sensor (300) is a first temperature; in a case that an ambient temperature of the temperature sensor (300) reaches a maximum value, the temperature collected by the temperature sensor (300) is a second temperature; and the second temperature threshold takes a smaller value of the first temperature and the second temperature.

19. The control method according to claim 12, characterized in that a range of the second temperature threshold is less than or equal to 280 degrees and greater than or equal to 300 degrees.
